(19) United States
(12) Patent Application Publication
(10) Pub. No.: US 2009/0085909 A1
(43) Pub. Date: Apr. 2, 2009

(54) Electro-wetting display device

(75) Inventors: Chun-Ming Chen, Miao-Li (TW); Shuo-Ting Yan, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/286,322

(22) Filed: Sep. 29, 2008

(30) Foreign Application Priority Data
Sep. 28, 2007 (CN) 200710077398.9

(51) Int. Cl. G09G 5/00

(52) U.S. Cl. 345/214

(57) ABSTRACT

An exemplary electro-wetting display (EWD) device (30) includes: a first substrate (31); a second substrate (38) parallel to the first substrate; partition walls (34) arranged in a lattice on the second substrate thereby defining a plurality of pixel regions (P); a first fluid (35); and a second fluid (36). The first and second fluids are immiscible with each other and disposed between the first and second substrates. The second fluid is electro-conductive or polar. The first fluid is provided between the second substrate and the second fluid. Each pixel region includes two switch elements (315, 316) and a storage capacitor (336). The switch elements and the storage capacitor are disposed at a same side of the pixel region.

### FIELD OF THE INVENTION

The present invention relates to an electro-wetting display (EWD) device including picture elements having first and second immiscible fluid within a space defined between a first substrate and a second substrate, the second fluid being electro-conductive or polar.

### GENERAL BACKGROUND

EWD devices display images by adjusting the amount of a source light that transmits through each of a multiplicity of tiny picture element regions. This adjustment is achieved by means of electrocapillarity (electro-wetting). EWD devices display images with excellent brightness and contrast, and with relatively low power consumption compared to many other display devices.

Referring to FIG. 10, this is a side cross-sectional view of part of a conventional EWD device 10, showing the EWD device 10 in a passive state with no voltage applied thereto. The EWD device 10 includes a transparent first substrate 11, a transparent second substrate 18 facing towards the first substrate 11, a first fluid 15, a second fluid 16, a plurality of partition walls 14, and at least two support plates (not shown). The support plates are provided between the two substrates 11, 18 for supporting the first substrate 11 in position. Thereby, the two substrates 11, 18 and the support plates define a sealed container (not labeled) filled with the first fluid 15 and the second fluid 16. A hydrophobic insulator 13, a driving circuit layer 12 and the second substrate 18 are stacked one on the other in that order from top to bottom. The partition walls 14 are arranged in a lattice on an inner surface of the hydrophobic insulator 13, thereby defining a plurality of pixel regions R. The first fluid 15 is an opaque fluid, and is located within the sealed container corresponding to the pixel regions R. The second fluid 16 is immiscible with the first fluid 15 but is in contact with the first fluid 15.

FIG. 11 is a top plan view of part of the driving circuit layer 12 of the EWD device 10. The driving circuit layer 12 includes an active driving circuit (not labeled) and a passivation layer (not shown) covering the active driving circuit. The active driving circuit includes a plurality of first driving lines 121 that are parallel to each other and that each extend along a first direction, a plurality of second driving lines 122 that are parallel to each other and that each extend along a second direction orthogonal to the first direction, a plurality of thin film transistors (TFTs) 124 that function as switching elements, a plurality of pixel electrodes 125, and a plurality of common lines 123. The first driving lines 121 and the second driving lines 122 cross each other and correspond to the partition walls 14, thereby defining a plurality of rectangular areas (not labeled) corresponding to the pixel regions R. In each pixel region R, one of the TFTs 124 is provided in the vicinity of a point of intersection of one of the first driving lines 121 and one of the second driving lines 122. The TFT 124 includes a gate electrode 140, a source electrode 150, and a drain electrode 160. The gate electrode 140, the source electrode 150, and the drain electrode 160 are connected to the corresponding first driving line 121, the corresponding second driving line 122, and a corresponding pixel electrode 125, respectively. Each pixel electrode 125 is generally rectangular, except that one corner of the rectangle is cut out. The TFT 124 is located in the cutout. Further, each common line 123 is arranged adjacent and parallel to a corresponding first driving line 121 that is far away from the TFT 124. The common line 123 includes a rectangular portion that protrudes inward toward the middle of the pixel region R. The protrusion portion underlies the pixel electrode 125, and defines a common electrode 127. The common electrode 127, the pixel electrode 125, and an insulating layer (not shown) therebetween cooperatively define a storage capacitor 126.

When no voltage is applied to the pixel region R, the first fluid 15 extends over an entire area of the pixel region R in a plane that is orthogonal to a direction in which light is transmitted through the pixel region R. Therefore the first fluid 15 functions as a shield layer and shields light beams, and the EWD device 10 displays a black image at the pixel region R.

When a driving voltage signal is applied to the pixel electrode 124 by the TFT 125 of the pixel region R, and a common voltage is applied to the second fluid 16 and the common line 123, an electric field is generated between the second fluid 16 and the pixel electrode 125. On the other hand, an upper left hand corner of the pixel region R where the TFT 124 is located is a non electric field area, and thus the hydrophobic insulator 13 corresponding to the TFT 124 remains less wettable. As a result, an interface between the first fluid 15 and the second fluid 16 changes due to electrocapillarity. The first fluid 15 moves towards the upper left hand corner and the second fluid 16 contacts the hydrophobic insulator 13 at positions vacated by the first fluid 15. Light transmitting through the second substrate 18 passes through the driving circuit layer 12, the hydrophobic insulator 13 and the second fluid 16, and the EWD device 10 displays a white image at the pixel region R.

Referring also to FIG. 12, in each pixel region R, the portion where the TFT 124 is arranged is defined as a TFT area R1, the portion adjacent to both the TFT area R1 and the corresponding first driving line 121 is defined as a peripheral area X, the portion where the storage capacitor 126 is located is defined as a storage capacitor area R2, and the main portion corresponding to a majority of the pixel electrode 125 is defined as a main area R3. Because the common electrode 127 is usually made of opaque material, the storage capacitor area R2 is an opaque area. In operation, when a driving voltage signal is applied, the electric field at the peripheral area X is weaker than that at the main area R3. Some of the first fluid 15 cannot move to the TFT area R1 completely, and remains at the peripheral area X. Thus the TFT area R1, the peripheral area X and the storage capacitor area R2 all tend to block light and darken the image at the pixel region R, even when the pixel region R works in an on state. Therefore, an aperture ratio of the EWD device 10 is relatively low.

What is needed, therefore, is an EWD device that can overcome the above-described deficiencies.

### SUMMARY

In an exemplary embodiment, an exemplary electro-wetting display (EWD) device includes: a first substrate; a second substrate facing the first substrate; a plurality of partition walls arranged in a lattice on the second substrate thereby defining a plurality of pixel regions; a first fluid and a second fluid. The first and second fluids are immiscible with each other and disposed between the first and second substrates. The second fluid is electro-conductive or polar. The first fluid is provided between the second substrate and the second fluid. Each pixel region includes at least one switch element and a storage capacitor. The at least one switch element and the storage capacitor are substantially disposed at one side of the pixel region.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of part of an EWD device according to a first embodiment of the present invention, the EWD device including a driving circuit layer and a plurality of pixel regions.

FIG. 2 is a top plan view of part of the driving circuit layer of FIG. 1, the part shown corresponding to one of the pixel regions.

FIG. 3 is a side cross-sectional view taken along line III-III of FIG. 2.

FIG. 4 is a side cross-sectional view taken along line IV-IV of FIG. 2.

FIG. 5 is a schematic view of FIG. 2, the pixel region defining a sub-region P1 and a sub-region P2.

FIG. 6 and FIG. 7 are top plan views of part of a driving circuit layer of an EWD device according to a second embodiment of the present invention, the part shown corresponding to one pixel region of the EWD device.

FIG. 8 is a side cross-sectional view taken along line VIII-VIII of FIG 7.

FIG. 9 is a top plan view of part of a driving circuit layer of an EWD device according to a third embodiment of the present invention, the part shown corresponding to one pixel region of the EWD device.

FIG. 10 is a side cross-sectional view of part of a conventional EWD device, the EWD device including a driving circuit layer and a plurality of pixel regions.

FIG. 11 is a top plan view of part of the driving circuit layer of the EWD device of FIG. 10, the part shown corresponding to one of the pixel regions.

FIG. 12 is a schematic view of FIG. 11, the pixel region defining areas R1, R2, R3, and X.

### DETAILED DESCRIPTION OF EMBODIMENTS

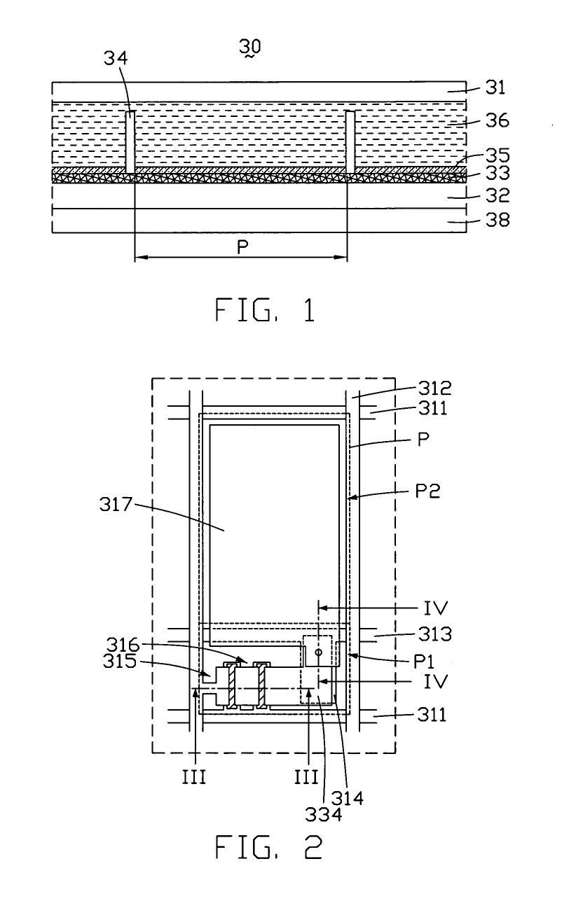

Referring to FIG. 1, this is a side cross-sectional view of part of an EWD device 30 according to a first embodiment of the present invention. The EWD device 30 includes a transparent first substrate 31, a transparent second substrate 38 parallel to and facing towards the first substrate 31, a first fluid 35, a second fluid 36, a plurality of partition walls 34, and at least two support plates (not shown). The support plates are provided between the two substrates 31, 38 for supporting the first substrate 31 in position. Thereby, the two substrates 31, 38 and the support plates define a sealed container (not labeled) filled with the first fluid 35 and the second fluid 36. A hydrophobic insulator 33, a driving circuit layer 32, and the second substrate 38 are stacked one on the other in that order from top to bottom. The partition walls 34 are arranged in a lattice on an inner surface of the hydrophobic insulator 33, thereby defining a plurality of pixel regions P. The first fluid 35 is an opaque fluid, and is sealed within the sealed container corresponding to the pixel regions R. The second fluid 36 is immiscible with the first fluid 35, but is in contact with the first fluid 35. In particular, when the EWD device 30 is in a passive state, the second fluid 36 fills the space between the first fluid 35 and the first substrate 31. The first fluid 35 can be, for example, an alkane-like hexadecane or colored oil. In this exemplary embodiment, the first fluid 35 is black oil. The second fluid 36 is electro-conductive or polar, for example, water or a salt solution (e.g. a solution of KCl in ethyl alcohol). The hydrophobic insulator 33 can be made of an amorphous fluoropolymer (e.g., AF 1600).

FIG. 2 is a top plan view of part of the driving circuit layer 32 of the EWD device 30. The driving circuit layer 32 includes an active driving circuit (not labeled), and a passivation layer (not shown) covering the active driving circuit. The active driving circuit includes a plurality of first driving lines 311 that are parallel to each other and that each extend along a first direction, a plurality of second driving lines 312 that are parallel to each other and that each extend along a second direction orthogonal to the first direction, a plurality of first TFTs 315 and second TFTs 316 that function as switching elements, a plurality of pixel electrodes 317, and a plurality of common lines 313. The first driving lines 311 and the second driving lines 312 cross each other and correspond to the partition walls 34, thereby defining a plurality of rectangular areas (not labeled) corresponding to the pixel regions P. Each pixel region P includes two opposite short sides corresponding to the two first driving lines 311, and two opposite long sides corresponding to the two second driving lines 312.

In each pixel region P, one common line 313 is arranged parallel with the two first driving lines 311. A distance between the common line 313 and one of the first driving lines 311 is two times that between the common line 313 and the other first driving line 311, thereby dividing the pixel region P into a small sub-region P1 and a large sub-region P2. The common line 313 includes a rectangular portion that protrudes into the sub-region P1 in a direction parallel to the long sides of the pixel region P. The rectangular portion forms a common electrode 314. A length of the common electrode 314 is 0.1-0.25 times a length of each long side of the pixel region P. One of the pixel electrodes 317 is arranged in the pixel region P, covering substantially the entire sub-region P2 and part of the sub-region P1. One of the first TFTs 315 and one of the second TFTs 316 are located in the sub-region P1, in an area thereof not covered by the pixel electrode 317.

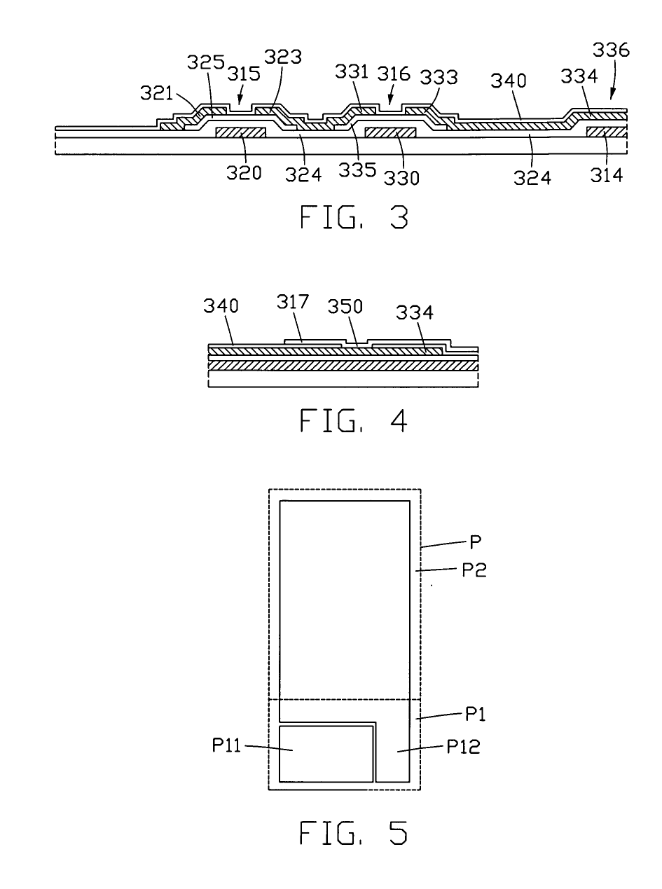

Referring also to FIG. 3 and FIG. 4, the first TFT 315 includes a first gate electrode 320, a first source electrode 321, a first drain electrode 323, and a first semiconductor layer 325. The second TFT 316 includes a second gate electrode 330, a second source electrode 331, a second drain electrode 333, and a second semiconductor layer 335. The first gate electrode 320 and the second gate electrode 330 both extend from the same first driving line 311. The first gate electrode 320, the second gate electrode 330, and the common electrode 314 are directly arranged on the second substrate 38. A gate electrode insulator 324 is formed over the second substrate 38 for covering the first gate electrode 320, the second gate electrode 330, and the common electrode 314. The first semiconductor layer 325 and the second semiconductor layer 335 are provided on portions of the gate electrode insulator 324 that correspond to the first gate electrode 320 and the second gate electrode 330, respectively. The first source electrode 321 and the first drain electrode 323 are respectively formed over the first semiconductor layer 325, symmetrically, thereby partly overlapping the first semiconductor layer 325. The second source electrode 331 and the second drain electrode 333 are respectively formed over the second semiconductor layer 335, symmetrically, thereby partly overlapping the second semiconductor layer 335. The first source electrode 321 is electrically coupled to one of the second driving lines 312. The first drain electrode 323 is electrically coupled to the second source electrode 331. The second drain electrode 333 extends towards the common electrode 314, thereby forming a drain electrode pad 334. The drain electrode pad 334, the common electrode 314, and the gate electrode insulator 324 therebetween cooperatively form a storage capacitor 336. Typically, the storage capacitor 336 is opaque. An insulating layer 340 is further arranged covering the first TFT 315, the second TFT 316, and the storage capacitor 336. A portion of the pixel electrode 317 fills a connecting hole 350 formed in the insulating layer 340. Thereby, the pixel electrode 317 contacts the drain electrode pad 334, and is electrically connected to the second drain electrode 333.

When a switch on voltage is applied to the first gate electrode 320 and the second gate electrode 330 via the first driving line 311, the first TFT 315 and the second TFT 316 are switched on. Then a data voltage is applied to the pixel electrode 317 via the second driving line 312, the first source electrode 321, the first drain electrode 323, the second source electrode 331, the second drain electrode 333, and the drain electrode pad 334 in sequence. Simultaneously, a common voltage is applied to the second fluid 36 and the common electrode 314 via the common line 313, thereby forming a voltage difference between the second fluid 36 and the pixel electrode 317. If the voltage difference is less than a threshold value, the first fluid 35 extends over the entire area of the pixel region P, and the second fluid 36 covers the entire first fluid 35. Thus the first fluid 35 functions as a shield layer and shields light beams passing up through the second substrate 38, and the EWD device 30 displays a black image at the pixel region P.

When the voltage difference is greater than the threshold value, the sub-region P1 where the first TFT 315 and the second TFT 316 are located is a non electric field area, and thus the hydrophobic insulator 33 corresponding to the first TFT 315 and the second TFT 316 remains less wettable. Therefore, an interface between the first fluid 35 and the second fluid 36 changes due to electrocapillarity, and the second fluid 36 pushes the first fluid 35 to move towards the sub-region P1 until the second fluid 36 contacts the hydrophobic insulator 33 in the sub-region P2. Light transmitting from the second substrate 38 passes through the hydrophobic insulator 33 and the second fluid 36 in sequence. Accordingly, the EWD device 30 displays a white image at the pixel region P.

Referring also to FIG. 5, this is a schematic view of the pixel region P, showing the sub-regions P1 and P2. The sub-region P2 is a transparent area, and the sub-region P1 is an opaque area. The sub-region P1 is further divided into a TFT region P11 where the first and second TFTs 315, 316 are located, and a storage capacitor region P12 where the common line 313 and the storage capacitor 336 are located. It is chiefly the opacity of the first and second TFTs 315, 316 and the storage capacitor 336 which contribute to the opacity of the sub-region P1.

In the above-described embodiment, the storage capacitor 336 is arranged adjacent to the second TFT 316. More particularly, the storage capacitor 336 overlaps a peripheral area around the first TFT 315 and the second TFT 316. In operation of the EWD device 30, even if some of the first fluid 35 remains at the peripheral area where the first and second TFTs 315, 316 are located (such peripheral area underlying the opaque storage capacitor 336), this does not reduce the aperture ratio of the EWD device 30. Therefore the EWD device 30 can have a relatively high aperture ratio.

Moreover, the storage capacitor 336 is made up of the drain electrode pad 334, the common electrode 314, and the gate electrode insulator 324 therebetween. The drain electrode pad 334 is close to the common electrode 314. Thus the area of the storage capacitor 336 can be relatively small, while the capacitance of the storage capacitor 336 can be as large as desired. This compactness of the storage capacitor 336 enables the opaque area of the storage capacitor 336 to be reduced. As a result, the aperture ratio of the pixel region P can be increased.

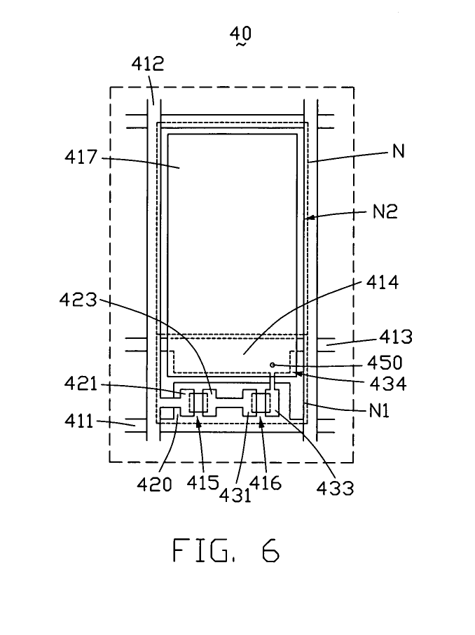

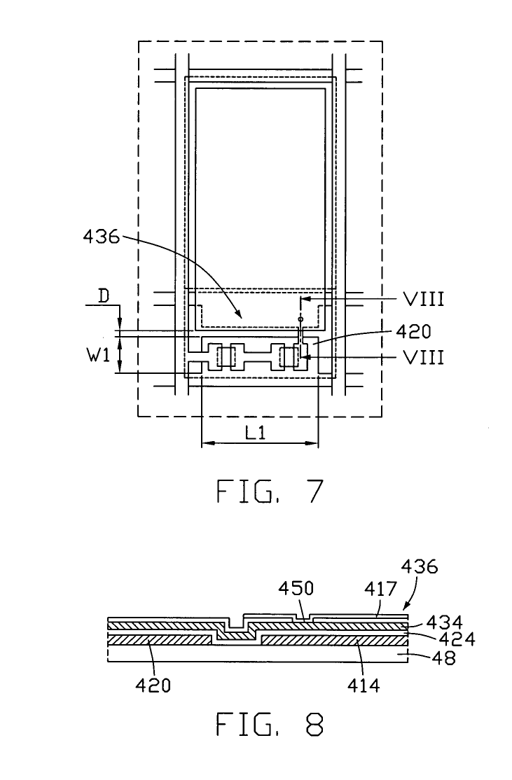

FIG. 6 and FIG. 7 show a pixel region of an EWD device 40 according to a second embodiment of the present invention. The EWD device 40 is similar to the EWD device 30, but differs in that a common electrode 414 is relatively large, and a first TFT 415 and a second TFT 416 share a rectangular gate electrode 420. A width of the common electrode 414 is 0.1-0.25 times a length of each long side of the pixel region N. The common electrode 414 continues from the left long side to the right long side of the pixel region N, thereby occupying a relative large area. A rectangular pixel electrode 417 substantially covers a sub-region N2 and the common electrode 414. A first driving line 411 nearest the common line 413 includes a portion protruding towards the common electrode 414, thereby forming the gate electrode 420. A length L1 of the gate electrode 420 is 0.7-0.98 times a length of each short side of the pixel region N, and a width W1 of the gate electrode 420 is 0.12 times a length of each long side of the pixel region N. The first TFT 415 and the second TFT 416 are arranged in the sub-region N1 and share the gate electrode 420 as a common gate electrode.

A source electrode 421 of the first TFT 415 is electrically coupled to a second driving line 412. A drain electrode 423 of the first TFT 415 is connected to a source electrode 431 of the second TFT 416. A drain electrode 433 of the second TFT 416 extends and overlaps the common electrode 414, thereby forming a drain electrode pad 434. The drain electrode pad 434 has a shape and a size approximately the same as a shape and a size of the common electrode 414. A distance D between the drain electrode pad 434 and the gate electrode 420 is in a range from 3 to 10 nanometers (nm), in order to avoid a so-called crosstalk phenomenon. The common electrode 414, the drain electrode pad 434, and a gate electrode insulator 424 therebetween cooperatively form a storage capacitor 436 (see also FIG. 8). A connecting hole 450 is formed above the drain electrode pad 434. The pixel electrode 417 fills the connecting hole 450, whereby the pixel electrode 417 is electrically coupled to the drain electrode pad 434.

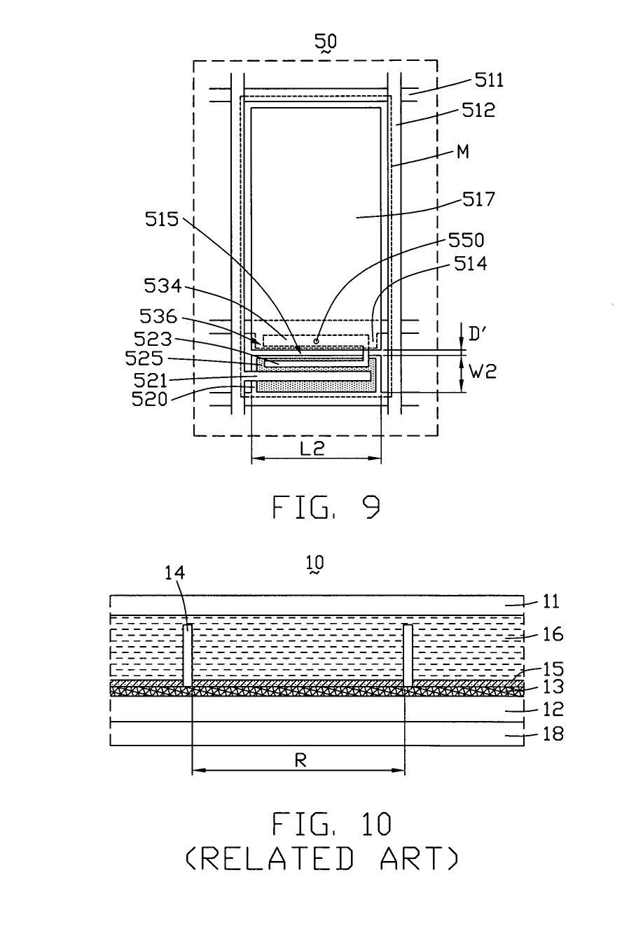

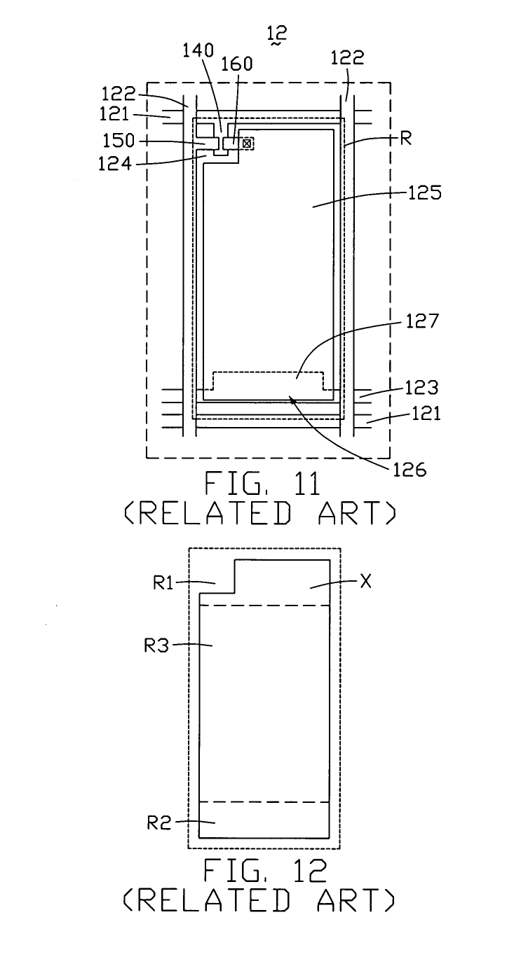

Referring to FIG. 9, this shows a pixel region of an EWD device 50 according to a third embodiment of the present invention. The EWD device 50 is similar to the EWD 40, but differs in that a pixel region M includes a TFT 515. The TFT 515 includes a gate electrode 520, a source electrode 521, a drain electrode 523, a semiconductor layer 525, and a gate insulator (not shown). The gate electrode 520 has a rectangular shape, and is formed by a protrusion extending from a first driving line 511 to the inside of the pixel region M. A length L2 of the gate electrode 520 is 0.7-0.98 times a length of each short side of the pixel region M, and a width W2 of the gate electrode 520 is 0.12 times a length of each long side of the pixel region M. The gate insulator covers the gate electrode 520 and a second substrate (not shown). The semiconductor layer 525 is arranged on the gate insulator corresponding to the gate electrode 520. The source electrode 521 is formed by an elongate protrusion extending from a second driving line 512 towards the inside of the pixel region M. The source electrode 521 overlaps part of the semiconductor layer 525. The drain electrode 523 overlaps part of the semiconductor layer 525, and extends towards and overlaps a common electrode 514, thereby forming a drain electrode pad 534. A gap D′ between the drain electrode pad 534 and the gate electrode 520 is in a range from 3 to 10 nanometers (nm), in order to avoid the so-called crosstalk phenomenon. The drain electrode pad 534 is electrically coupled to the pixel electrode 517 via a connecting hole 550. The common electrode 514, the drain electrode pad 534, and the gate insulator therebetween cooperatively form a storage capacitor 536.

In the above-described EWD devices 30, 40, 50, the gate electrodes of the TFTs can be made of aluminum (Al) or aluminum and neodymium (Ne) alloy. The drain electrode and source electrode can be made of molybdenum (Mo), or be multilayer structure including molybdenum, nickel (Ni), and lanthanum (La). The distance from the common line to the nearest short side of the pixel region can be 0.2-0.5 times a length of each long side of the pixel region. When said distance is 0.33 times the length of each long side of the pixel region, an aperture ratio of the pixel region can be as high as at least 66.6%. For example, in the EWD device 30 of the first embodiment, the aperture ratio can be more than 70%.

It is to be further understood that even though numerous characteristics and advantages of preferred and exemplary embodiments have been set out in the foregoing description, together with details of structures and functions associated with the embodiments, the disclosure is illustrative only; and that changes may be made in detail (including in matters of shape, size and arrangement of parts) within the principles of the invention to the full extent indicated by the broad general meaning of the terms in which the appended claims are expressed.

What is claimed is:

1. An electro-wetting display (EWD) device, comprising:
a first substrate;
a second substrate parallel to the first substrate;
a plurality of partition walls arranged in a lattice on the second substrate thereby defining a plurality of pixel regions; and
a first fluid and a second fluid, the first and second fluids immiscible with each other and disposed between the first and second substrates, the second fluid being electro-conductive or polar, the first fluid provided between the second substrate and the second fluid;
wherein each pixel region comprises at least one switch element and a storage capacitor, the at least one switch element and the storage capacitor are both disposed at a same side of the pixel region.

2. The EWD device of claim 1, wherein each pixel region further comprises a pixel electrode connected to the switch element, the pixel electrode occupying a main region of the pixel region other than where the at least one switch element is located.

3. The EWD device of claim 2, wherein each pixel region further comprises a common line connected to one electrode of the storage capacitor.

4. The EWD device of claim 3, wherein each pixel region further comprises two opposite short sides and two opposite long sides, and the at least one switch element and the storage capacitor are disposed adjacent to one of the short sides.

5. The EWD device of claim 4, wherein the common line is parallel and proximate to the same short side that the at least one switch element is adjacent to.

6. The EWD device of claim 5, wherein a distance between the common line and the short side is 0.2-0.5 times a length of each long side of the pixel region.

7. The EWD device of claim 3, wherein a length of the storage capacitor electrode connected to the common line is 0.1-0.25 times a length of each long side of the pixel region.

8. The EWD device of claim 4, further comprising a plurality of first driving lines and a plurality of second driving lines that cross each other and correspond to the partition walls.

9. The EWD device of claim 8, wherein the at least one switch element comprises one transistor with a gate electrode connected to one corresponding first driving line, a source electrode connected to one corresponding second driving line, and a drain electrode connected to the pixel electrode and the other electrode of the storage capacitor.

10. The EWD device of claim 8, wherein the at least one switch element comprises a first transistor and a second transistor, gate electrodes of the first and second transistors are connected to one corresponding first driving line, a source electrode of the first transistor is connected to one corresponding second driving line, a drain electrode of the first transistor is connected to a source electrode of the second transistor, and a drain electrode of the second transistor is connected to the pixel electrode and the other electrode of the storage capacitor.

11. The EWD device of claim 8, wherein the at least one switch element comprises a first transistor and a second transistor, the first and second transistors share a common gate electrode, the gate electrode is connected to one corresponding first driving line, a source electrode of the first transistor is connected to one corresponding second driving line, a drain electrode of the first transistor is connected to a source electrode of the second transistor, and a drain electrode of the second transistor is connected to the pixel electrode and the other electrode of the storage capacitor.

12. The EWD device of claim 11, wherein a width of the gate electrode is 0.7-0.98 times a length of each short side of the pixel region.

13. The EWD device of claim 1, further comprising a hydrophobic insulator disposed between the first fluid and the second substrate.

14. An electro-wetting display (EWD) device, comprising:
a first substrate;
a second substrate parallel to the first substrate;
a driving circuit layer provided at the second substrate;
a plurality of partition walls arranged in a lattice on the driving circuit layer, thereby defining a plurality of pixel regions, each pixel region having two short sides and two long sides; and
a first fluid and a second fluid, the first and second fluids immiscible with each other and disposed between the driving circuit layer and the first substrate, the second fluid being electro-conductive or polar, the first fluid provided between the driving circuit layer and the second fluid;
wherein part of the driving circuit layer corresponding to each pixel region comprises at least one transistor and a common line, and the at least one transistor and the common line are disposed in a same part of the pixel region adjacent to one of the short sides of the pixel region.

15. The EWD device of claim 14, wherein a distance from the common line to said one of the short sides of the pixel region is 0.2-0.5 times a length of each long side of the pixel region.

16. The EWD device of claim 14, wherein a portion of the common line extends toward said one of the short sides thereby forming a common electrode.

17. The EWD device of claim 15, wherein the at least one transistor comprises a transistor with a drain electrode overlapping the common electrode thereby forming a drain electrode pad, and the drain electrode pad and the common electrode cooperatively define a storage capacitor.

18. The EWD device of claim 15, wherein the driving circuit layer further comprises a plurality of first driving lines and a plurality of second driving lines that cross each other and correspond to the partition walls.

19. The EWD device of claim 17, wherein the at least one switch element comprises a first transistor and a second transistor, gate electrodes of the first and second transistors are connected to one corresponding first driving line, a source electrode of the first transistor is connected to one corresponding second driving line, a drain electrode of the first transistor is connected to a source electrode of the second transistor, and a drain electrode of the second transistor is connected to the pixel electrode and an electrode of the storage capacitor.
